(19) United States
(12) Patent Application Publication
(10) Pub. No.: US 2024/0224068 A1
(43) Pub. Date: Jul. 4, 2024

(54) METHOD FOR NETWORK NODE INTEGRATION

(71) Applicant: ZTE Corporation, Shenzhen (CN)

(72) Inventors: Wei Cao, Shenzhen (CN); Nan Zhang, Shenzhen (CN); Ziyang Li, Shenzhen (CN); Hanqing Xu, Shenzhen (CN); Jian Li, Shenzhen (CN)

(73) Assignee: ZTE Corporation, Shenzhen (CN)

(21) Appl. No.: 18/606,749

(22) Filed: Mar. 15, 2024

Related U.S. Application Data
(63) Continuation of application No. PCT/CN2022/073588, filed on Jan. 24, 2022.

(51) Int. Cl. H04W 16/26; H04W 74/0833

(52) U.S. Cl. CPC H04W 16/26; H04W 74/0833

(57) ABSTRACT

Method, device and computer program product for wireless communication are provided. A method includes: performing, by a wireless communication node with a network node, an initial access process; and identifying, by the wireless communication node, the network node according to a message from the network node in the initial access process or after the initial access process; wherein the network node is adopted to amplify signals between the wireless communication node and a user equipment.

### CROSS-REFERENCE TO RELATED APPLICATIONS

This application is a continuation of PCT/CN2022/073588, filed on Jan. 24, 2022, titled “METHOD FOR NETWORK NODE INTEGRATION”, and published as WO 2023/137764 A1, the entirety of which is incorporated herein by reference.

### TECHNICAL FIELD

This document is directed generally to wireless communications, and in particular to 5th generation (5G) communications.

### BACKGROUND

As the new radio (NR) system moves to higher frequencies (around 4 GHz for FR1 deployments and above 24 GHz for FR2), propagation conditions degrade compared to lower frequencies exacerbating the coverage challenges. As a result, further densification of cells may be necessary. While the deployment of regular full-stack cells is preferred, it may not always be a possible (e.g., not availability of backhaul) or economically viable option. To provide blanket coverage in cellular network deployments with relatively low cost, RF repeaters with full-duplex amplify-and-forward operation have been used in 2G, 3G and 4G systems. However, the major problem brought by the RF repeater is that it amplifies both signal and noise and increases interference in the system.

Another common property of the NR systems is the use of multi-beam operation with associated beam management in the higher frequency bands defined for TDD. The multi-antenna techniques consisting of massive MIMO for FR1 and analog beamforming for FR2 assist in coping with the challenging propagation conditions of these higher frequency bands. The RF repeater without beam management functions cannot provide beamforming gain in its signal forwarding.

### BACKGROUND

This document relates to methods for the network node integration for a cellular network with the smart nodes, devices thereof and systems thereof.

RF repeaters have been used in 2G, 3G and 4G deployments to supplement the coverage provided by regular full-stack cells with various transmission power characteristics. They constitute the simplest and most cost-effective way to improve network coverage. The main advantages of RF repeaters are their low-cost, their ease of deployment and the fact that they do not increase latency. The main disadvantage is that they amplify signal and noise and, hence, may contribute to an increase of interference (pollution) in the system. Within RF repeaters, there are different categories depending on the power characteristics and the amount of spectrum that they are configured to amplify (e.g., single band, multi-band, etc.). RF repeaters are a non-regenerative type of relay nodes and they simply amplify-and-forward everything that they receive. RF repeaters are typically full-duplex nodes and they do not differentiate between UL and DL from a transmission or reception standpoint.

One aspect of the present disclosure relates to a wireless communication method. In an embodiment, the wireless communication method includes: performing, by a wireless communication node with a network node, an initial access process; and identifying, by the wireless communication node, the network node according to a message from the network node in the initial access process or after the initial access process; wherein the network node is adopted to amplify signals between the wireless communication node and a user equipment.

Another aspect of the present disclosure relates to a wireless communication method. In an embodiment, the wireless communication method includes: transmitting, by a network node to a wireless communication node, a message in an initial access process or after the initial access process, to allow the wireless communication node to identify the network node according to the message; wherein the network node is adopted to amplify signals between the wireless communication node and a user equipment.

Another aspect of the present disclosure relates to a wireless communication method. In an embodiment, the wireless communication method includes: receiving, by a wireless communication node from a network node, an identity report message comprising an identity of the network node; and performing, by the wireless communication node, an authentication for the network node according to the identity of the network node; wherein the network node is adopted to amplify signals between the wireless communication node and a user equipment.

Another aspect of the present disclosure relates to a wireless communication method. In an embodiment, the wireless communication method includes: transmitting, by a network node to a wireless communication node, an identity report message comprising an identity of the network node to allow the wireless communication node to perform an authentication for the network node according to the identity of the network node; wherein the network node is adopted to amplify signals between the wireless communication node and a user equipment.

Another aspect of the present disclosure relates to a wireless communication node. In an embodiment, the wireless communication node includes a communication unit and a processor. In an embodiment, the processor is configured to: perform, with a network node, an initial access process; and identify the network node according to a message from the network node in the initial access process or after the initial access process; wherein the network node is adopted to amplify signals between the wireless communication node and a user equipment.

Another aspect of the present disclosure relates to a wireless communication node. In an embodiment, the wireless communication node includes a communication unit and a processor. In an embodiment, the processor is configured to: transmit, to a wireless communication node, a message in an initial access process or after the initial access process, to allow the wireless communication node to identify the network node according to the message; wherein the network node is adopted to amplify signals between the wireless communication node and a user equipment.

Another aspect of the present disclosure relates to a wireless communication node. In an embodiment, the wireless communication node includes a communication unit and a processor. In an embodiment, the processor is configured to: receive, from a network node, an identity report message comprising an identity of the network node; and perform an authentication for the network node according to the identity of the network node; wherein the network node is adopted to amplify signals between the wireless communication node and a user equipment.

Another aspect of the present disclosure relates to a wireless communication node. In an embodiment, the wireless communication node includes a communication unit and a processor. In an embodiment, the processor is configured to: transmit, to a wireless communication node, an identity report message comprising an identity of the network node to allow the wireless communication node to perform an authentication for the network node according to the identity of the network node; wherein the network node is adopted to amplify signals between the wireless communication node and a user equipment.

Various embodiments may preferably implement the following features:

Preferably, the network node is identified based on a Random Access Channel Occasion, RO, and a Physical Random Access Channel, PRACH, preamble.

Preferably, the network node is identified when the wireless communication node detects the PRACH preamble with a contention free PRACH preamble index corresponding to the network node during the RO.

Preferably, the network node is identified based on a contention-based Physical Random Access Channel, PRACH, preamble and a Random Access Radio Network Temporary Identifier, RA-RNTI.

Preferably, the network node is identified when the wireless communication node receives a reply for a Random Access Response, RAR, scrambled by a RA-RNTI corresponding to the network node.

Preferably, the network node is identified when the wireless communication node receives a reply for an RAR scrambled by the RA-RNTI with an offset corresponding to the network node.

Preferably, the network node is identified based on a content of a message of a scheduled transmission.

Preferably, the scheduled transmission is a scheduled transmission after a successful initial access process, or a data payload sent together with a preamble.

Preferably, the network node is identified when the wireless communication node receives an indication corresponding to the network node in an identity field or in an establishment cause field in the content of the message.

Preferably, the network node is identified based on an indication corresponding to the network node in a higher layer message received from the network node.

Preferably, the higher layer message is a registration request, and a connection between the network node and the wireless communication node is released when the wireless communication node receives a registration rejection from a core network.

Preferably, the method further comprises: transmitting, by the wireless communication node to the network node, an indication indicating that the network node is supported by the wireless communication node.

Preferably, the method further comprises: receiving, by the network node from the wireless communication node, an indication indicating that the network node is supported by the wireless communication node.

Preferably, the method further comprises: transmitting, by the wireless communication node to the network node, a request for the identity of the network node.

Preferably, the method further comprises: transmitting, by the wireless communication node to the network node, an access rejection in response to the authentication for the network node having failed.

Preferably, the identity report message is identified based on a Medium Access Control, MAC, subheader.

Preferably, the method further comprises: receiving, by the network node from the wireless communication node, a request for the identity of the network node.

Preferably, the method further comprises: receiving, by the network node from the wireless communication node, an access rejection in response to the authentication for the network node having failed.

Preferably, the identity report message is identified based on a Medium Access Control, MAC, subheader.

The present disclosure relates to a computer program product comprising a computer-readable program medium code stored thereupon, the code, when executed by a processor, causing the processor to implement a wireless communication method recited in any one of foregoing methods.

To cope with the unwanted interference, a smart node (SN) can be considered, which makes use of the control information from a BS to enable an intelligent amplify-and-forward operation. The SN is located in a position where it can receive signals from the BS via wireless communication. When the SN starts up, a network integration procedure is needed. Via this network integration procedure, the BS identifies the SN as a network node and configures the SN for its following amplify-and-forward operation.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of the working steps of an SN according to an embodiment of the present disclosure.

FIG. 2 shows a schematic diagram of communication links and forwarding links according to an embodiment of the present disclosure.

FIG. 3 shows a tree diagram illustrating various of methods and corresponding cases according to embodiments of the present disclosure.

FIG. 4 shows an example of a schematic diagram of a wireless terminal according to an embodiment of the present disclosure.

FIG. 5 shows an example of a schematic diagram of a wireless network node according to an embodiment of the present disclosure.

FIG. 6 shows 4 step RACH and 2 step RACH according to an embodiment of the present disclosure.

FIG. 7 shows a higher layer message flow according to an embodiment of the present disclosure.

FIGS. 8, 9, 10, and 11 show flowcharts of methods according to embodiments of the present disclosure.

### DETAILED DESCRIPTION

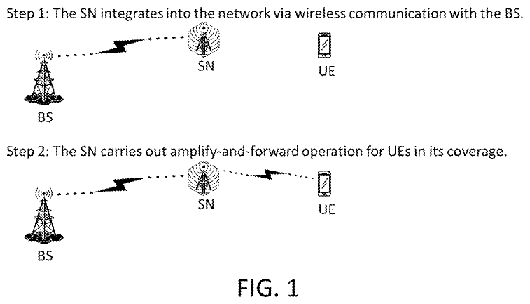

In an embodiment, referring to FIG. 1 which illustrates the working steps of an SN, the SN is located in a position where it can receive signals from the BS via wireless communications. When the SN starts up, a network integration procedure is carried out. Via this network integration procedure, the SN (1) is identified by the BS as a network node and (2) is configured for its following amplify-and-forward operation.

After the completion of integration, the SN carries out amplify-and-forward operation for UEs in its coverage with the control information received from the BS.

The SN consists of 2 functional parts: one is the communication unit (CU) and the other is the forwarding unit (FU). The CU includes, but is not limited to, a mobile terminal or a device with part of UE function. The FU includes, but is not limited to, a radio unit of a BS or a RIS (Reconfigurable Intelligent Surfaces).

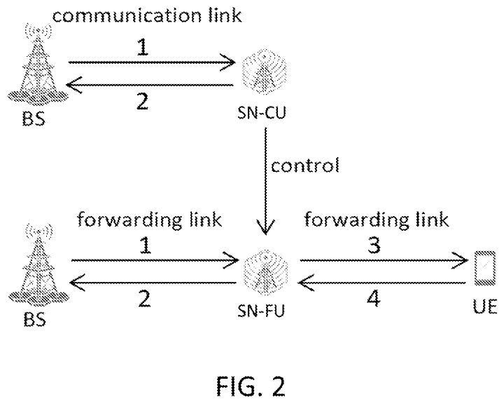

FIG. 2 illustrates links according to an embodiment of the present disclosure. As illustrated in FIG. 2, the links between the BS, the SN and the UE are defined below.

In this disclosure, a communication link is the link between the BS and the SN-CU. The indexes 1 and 2 indicate DL and UL directions, respectively. Using the communication link, the SN-CU acts like a UE to carry out initial access, measurements and reception of control information. The control information for the SN-FU is also received by the SN-CU from the BS via the communication link.

In this disclosure, a forwarding link is the forwarding link used between the BS and the SN-FU, and between the SN-FU and the UE. Similarly, the indexes 1 to 4 are used to indicate directions. The SN-FU carries out intelligent amplify-and-forward operation using the control information received by the SN-CU from the BS.

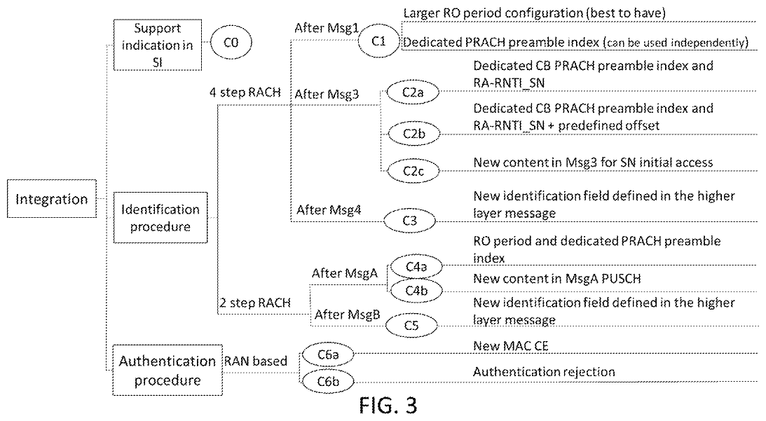

FIG. 3 shows a tree diagram illustrating various methods and corresponding cases according to embodiments of the present disclosure. Referring to FIG. 3, each respective case will be described in detail in the following disclosure.

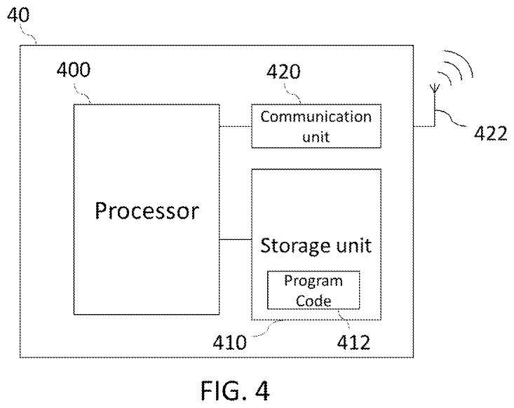

FIG. 4 relates to a schematic diagram of a wireless terminal 40 according to an embodiment of the present disclosure. The wireless terminal 40 may be a user equipment (UE), a mobile phone, a laptop, a tablet computer, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 412 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g. messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code.

The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g. a base station).

FIG. 5 relates to a schematic diagram of a wireless network node 50 according to an embodiment of the present disclosure. The wireless network node 50 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 50 may comprise (perform) at least one network function such as an access and mobility management function (AMF), a session management function (SMF), a user place function (UPF), a policy control function (PCF), an application function (AF), etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 512 include but are not limited to a SIM, ROM, flash memory, RAM, hard-disk, and optical data storage device. The communication unit 520 may be a transceiver and is used to transmit and receive signals (e.g. messages or packets) according to processing results of the processor 600. In an example, the communication unit 520 transmits and receives the signals via at least one antenna 522 shown in FIG. 5.

In an embodiment, the storage unit 510 and the program code 512 may be omitted. The processor 500 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g. a user equipment or another wireless network node).

### SN Support Indication in SI

### Case 0 (C0)

In an embodiment, if the SN deployment is an optional feature, an indication (e.g., named “sn-Support”) may be added into the system information, e.g., in SIB1. When an SN starts up, it performs cell search, system information acquisition as a UE. Then the SN checks the indication sn-Support in the system information to determine whether the cell is accessible.

For normal UEs, a cellBarred indication is included in the system information, e.g., MIB to prevent the UE from accessing the cell (e.g., the cell is overloaded). This indication may be ignored by the SN. That is, when the SN receives the system information with the cellBarred indication corresponding to a cell, the SN can still access the cell.

### Identification Procedure of an SN

Since the SN communicates with the BS via wireless channels like a UE, its integration can be carried out similar to the initial access procedure of a UE. The SN carries out its initial access using the communication links 1 and 2.

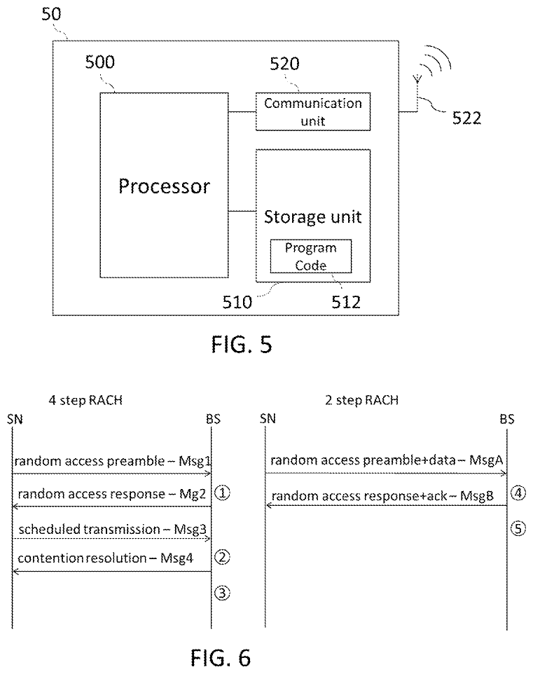

The initial access message flow is illustrated in FIG. 6. FIG. 6 shows the possible points for the SN identification according to an embodiment of the present disclosure. Both the “4 step RACH” and the “2 step RACH” procedures can be used by the SN, if the BS supports the corresponding RACH procedure. FIG. 6 also shows the messages Msg1, Msg2, Msg3, Msg4 in the 4 step RACH procedure, and messages MsgA and MsgB in the 2 step RACH procedure. The SN identification can be carried out by the BS at different points 1 to 5 (shown in FIG. 6 with circles). Since the SN may transparently forward the received signal from the BS/UE to the UE/BS, the identification at points 1, 2 and 4 is preferred to have less impact on the CN (core network).

In an embodiment, in the “4 step RACH” procedure (see FIG. 6), the SN is identified by the BS at point 1, i.e., after the BS receives the PRACH preamble. In this scenario, the following case may be considered.

RO period configuration and dedicated PRACH preamble index—Case 1 (C1)

As for the RO period configuration for SN, since the deployment of an SN does not change frequently, the RO period for SNs can be longer than that of normal UE's. There are the following options: 1) a predefined RO period (e.g., 640 ms) can be used by the SN; and 2) an RO period can be configured by OAM at the deployment of the SN.

As for the dedicated PRACH preamble index, in order to identify an SN from the received PRACH preamble, the BS needs to reserve dedicated preamble resource for the SN. In the current NR specification, the PRACH preambles are divided into contention based (CB) and contention free (CF).

A dedicated CF PRACH preamble index can be used to provide initial access opportunity for SN. For example, the first or the last CF PRACH preamble index can be reserved for SN's initial access during the corresponding RO. The BS may guarantee that the dedicated CF PRACH preamble index is not assigned to any UE using CF PRACH during the corresponding RO. If a BS detects a PRACH preamble with the dedicated CF PRACH preamble index during the corresponding RO, the BS can identify the preamble sent by an SN.

The technical advantages of this method include: (1) reducing the impact on CF PRACH capacity with a sparser RO configuration, and (2) reducing the BS's workload of SN detection.

In an embodiment, in the “4 step RACH” procedure (see FIGS. 3 and 6), the SN is identified by the BS at point 2, i.e., after the BS receives the first scheduled transmission (i.e., Msg3 in the LTE/NR specifications). In this scenario, the following cases may be considered.

### Dedicated CB PRACH Preamble Index and RA-RNTI-SN—Case 2a (C2a)

A dedicated CB PRACH preamble index with a dedicated RNTI can be used to identify an SN's initial access. For example, the first or the last CB PRACH preamble index can be reserved for SN's initial access during the corresponding RO. Since the initial access of an SN is expected to be less frequent, a dedicated RA-RNTI-SN can be predefined, e.g., 0xFFFD. If a BS detects a PRACH preamble with the dedicated CB PRACH preamble index during the corresponding RO, the BS sends an RAR scrambled with the RA-RNTI-SN. The SN detects the RAR with the RA-RNTI-SN. If the SN correctly receives the RAR for it and replies with a Msg3. The BS can identify the preamble is sent by an SN.

The technical advantages of this method include that it is possible for the BS to send two RARs with the RA-RNTI-SN and the RA-RNTI, respectively. If there is a normal UE that collides with the SN using the dedicated CB PRACH preamble index, the UE can receive the RAR with the RA-RNTI, and the SN can receive the RAR with the RA-RNTI-SN.

### Dedicated CB PRACH Preamble Index and RA-RNTI+ Predefined Offset—Case 2b (C2b)

An offset for RA-RNTI can be predefined or configured by OAM. A dedicated CB PRACH preamble index with the RA-RNTI offset can be used to identify an SN's initial access. For example, the first or the last CB PRACH preamble index can be reserved for SN's initial access during the corresponding RO. If a BS detects a PRACH preamble with the dedicated CB PRACH preamble index during the corresponding RO, the BS sends a RAR scrambled with the RA-RNTI with an offset (also presented as RA-RNTI+offset). The SN detects the RAR with the RA-RNTI+offset. If the SN correctly receives the RAR for it and replies with a Msg3. The BS can identify the preamble is sent by an SN.

The technical advantages of this method include that it is possible for the BS to send two RARs with the RA-RNTI+offset and the RA-RNTI, respectively. If there is a normal UE that collides with the SN using the dedicated CB PRACH preamble index, the UE can receive the RAR with the RA-RNTI, and the SN can receive the RAR with the RA-RNTI+offset.

### New Content in Msg3 for SN Initial Access—Case 2c (C2c)

In order to identify an SN from the first scheduled transmission (i.e., Msg3), new content in the Msg3 can be considered. In some approaches, the Msg3 contains the RRCSetupRequest message. In an example, the content of the RRCSetupRequest message is as follows.

```
  -- ASN1START
  -- TAG-RRCSETUPREQUEST-START
```

| | |
|---|---|
| RRCSetupRequest ::= | SEQUENCE{ |
| rrcSetupRequest | RRCSetupRequest-IES |
| } | |
| RRCSetupRequest-IEs ::= | SEQUENCE { |
| ue-Identitiy | InitialUE-Identity, |
| establishmentCause | EstablishmentCause, |
| spare | BIT STRING (SIZE (1)) |
| } | |
| InitialUE-Identity ::= | CHOICE { |
| ng-5G-S-TMSI-Part1 | BIT STRING (SIZE (39)), |
| random Value | BIT STRING (SIZE (39)) |
| } | |
| EstablishmentCause ::= | ENUMERATED { |
| | emergency, highPriorityAccess, mt- |
| Access, mo-Signalling, | |
| | mo-Data, mo-VoiceCall, mo-SMS, mps- |

Priority Acces, mcs-PriorityAccess,

| | |
|---|---|
| | spare 6, spare 5, spare 4, spare 3, spare |
| 2, spare 1} | |

```
  -- TAG-RRCSETUPREQUEST-STOP
  -- ANS1STOP
```

To identify an SN with the RRCSetupRequest message, the following options can be considered, in which the second option is preferred due to no impact on normal UE's initial access.

As a first option, a predefined UE-Identity can be used. Since the ng-5G-S-TMSI-part1 is assigned by CN, it is not suitable for SN's identification at point 2. Therefore, the field random Value with a predefined value can be used to identify an SN. For example, value 0 or value 239-1 can be considered as the predefined value. In this case, the predefined value cannot be used by normal UEs in their initial access. Otherwise, the BS cannot tell the SN from the normal UEs by the UE-Identity field.

As a second, and more preferred option, a dedicated EstablishmentCause can be used. A new value can be defined for SN's initial access in the EstablishmentCause field. For example, the spare6 can be redefined as “sn-Access” for the identification of an SN.

In an embodiment, in the “4 step RACH” procedure (see FIGS. 3 and 6), the SN is identified by the BS at point 3, i.e., after the SN finishes its initial access successfully. In this scenario, the following case may be considered.

### New Identification Field Defined in the Higher Layer Message—Case 3 (C3)

After successful initial access, the SN sends an RRCSetupComplete message to the BS and registers to the CN like a UE. To support identification at the BS side, a new indication field (e.g., named “smart-NodeIndication”) can be added into the RRCSetupComplete message. This field is optional and with an enumerate type of value range {true, false}.

In addition, this method can be used together with the RAN based SN identification to improve the network access security.

The CN determines whether to accept the Registration Request according to the reported smart-NodeIndication. If the smart-NodeIndication is illegal, the CN replies with a Registration Rejection to the BS. The BS forwards the Registration Rejection and releases the connection with the SN accordingly.

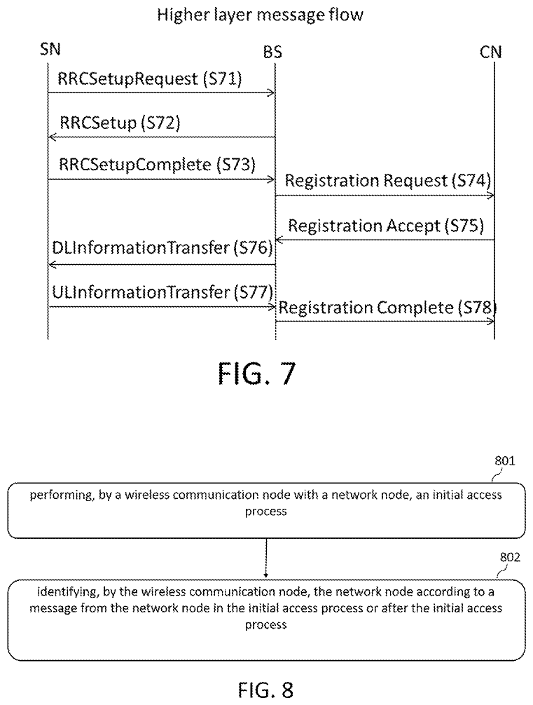

FIG. 7 shows an illustration of the higher layer message flow in accordance with an embodiment of the present disclosure. As shown in FIG. 7, the SN first sends S71 a RRCSetupRequest to the BS and receives S72, as a response, a RRCSetup. The SN sends S73, to the BS, the RRCSetupComplete message. The BS sends S74 to the CN a Registration Request. The CN sends S75 to the BS a registration accept message. The BS sends S76 a message to the SN comprising DL information transfer. The UE sends S77 to the BS a message to the BS comprising UL information transfer. Finally, the BS sends S78 a registration complete message to the CN.

In an embodiment, in the 2 step RACH procedure (see FIGS. 3 and 6), the SN is identified by the BS at point 4, i.e., after the BS receives the random-access preamble+data. In this scenario, the following cases may be considered.

### RO Period Configuration and Dedicated PRACH Preamble Index—Case 4a (C4a)

The same method as of Case 1 can be reused. The benefit of this method includes: (1) reduction of the impact on CF PRACH capacity with a sparser RO configuration, (2) reduction of the BS's workload of SN detection.

### New Content in MsgA PUSCH for SN Initial Access—Case 4b (C4b)

The MsgA PUSCH contains the RRCSetupRequest message. In this case, the method in Case 2c can be reused to identify the SN.

If only the MsgA PRACH is successfully detected, the BS sends the MsgB to ask the SN falls back to 4 step RACH like a normal UE.

In an embodiment, in the 2 step RACH procedure (see FIGS. 3 and 6), the SN is identified by the BS at point 5, i.e., after the SN finishes its initial access with data successfully. In this scenario, the following case may be considered.

### New Identification Field Defined in the Higher Layer Messages—Case 5 (C5)

The higher layer message flow is the same as that in the 4 step RACH. In this case, the method as explained above for Case 3 can be reused by the BS to identify an SN.

In addition, this method can be used together with the RAN based SN identification to improve the network access security.

### The RAN Based Authentication Procedure of an SN

The SN can be authenticated by the RAN after its successful initial access. Using this procedure, the authentication can be carried out by RAN, which reduces the impact on CN.

In various embodiments, the following cases may be considered.

### New MAC CEs for SN ID Acquisition—Case 6a (C6a)

The BS sends an SN ID Request MAC CE to the SN-CU and the SN-CU replies with a SN ID Report MAC CE to the BS.

The SN ID Request MAC CE is identified by MAC sub-header with a predefined LCID. For example, the value 46 can be used for the current NR system. It has a fixed size of zero bits.

The SN ID Report MAC CE is identified by MAC sub-header with a predefined LCID. For example, the value 44 can be used for the current NR system. It has a predefined size and consists of a single field which contains the SN ID. The SN ID is a network node identity assigned by a network node manufacturer or configured by OAM. The legality of the SN ID is recognizable by a BS.

### Authentication Rejection—Case 6b (C6b)

The BS checks the received SN ID Report MAC CE and determines whether the SN is a legal network node for current cell. If the BS determines the SN is illegal, it sends an SN Access Reject MAC CE to the SN-CU. The SN Access Reject MAC CE is identified by MAC sub-header with a predefined LCID. For example, the value 45 can be used for the current NR system. It has a fixed size of zero bits.

FIG. 8 shows a flowchart of a method according to an embodiment of the present disclosure. The method shown in FIG. 8 may be used in a BS and comprises:

Step 801: performing, by a wireless communication node (e.g. BS) with a network node (e.g. SN), an initial access process.

Step 802: identifying, by the wireless communication node, the network node according to a message from the network node in the initial access process or after the initial access process.

In this embodiment, the network node is adopted to amplify signals between the wireless communication node and a user equipment.

In an embodiment, the network node is identified based on a Random Access Channel Occasion, RO, and a Physical Random Access Channel, PRACH, preamble.

In an embodiment, the network node is identified when the wireless communication node detects the PRACH preamble with a contention free PRACH preamble index corresponding to the network node during the RO.

In an embodiment, the network node is identified based on a contention-based Physical Random Access Channel, PRACH, preamble and a Random Access Radio Network Temporary Identifier, RA-RNTI.

In an embodiment, the network node is identified when the wireless communication node receives a reply for a Random Access Response, RAR, scrambled by a RA-RNTI corresponding to the network node.

In an embodiment, the network node is identified when the wireless communication node receives a reply for an RAR scrambled by the RA-RNTI with an offset corresponding to the network node.

In an embodiment, the network node is identified based on a content of a message of a scheduled transmission.

In an embodiment, the scheduled transmission is a scheduled transmission after a successful initial access process, or a data payload sent together with a preamble.

In an embodiment, the network node is identified when the wireless communication node receives an indication corresponding to the network node in an identity field or in an establishment cause field in the content of the message.

In an embodiment, the network node is identified based on an indication corresponding to the network node in a higher layer message received from the network node.

In an embodiment, the higher layer message is a registration request, and a connection between the network node and the wireless communication node is released when the wireless communication node receives a registration rejection from a core network.

In an embodiment, the method further comprises: transmitting, by the wireless communication node to the network node, an indication indicating that the network node is supported by the wireless communication node.

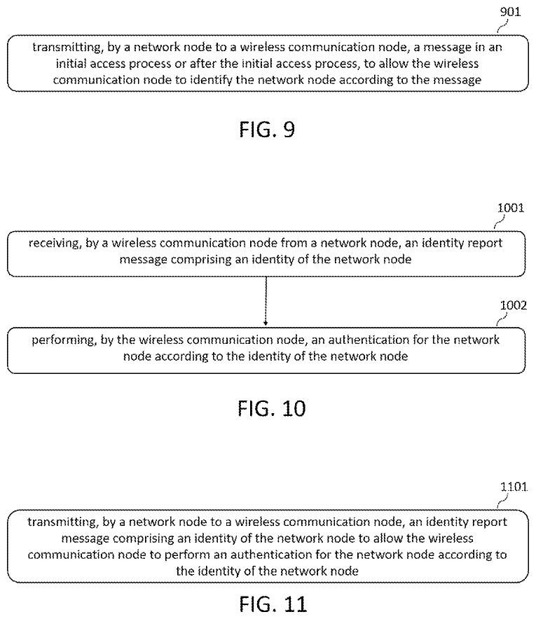

FIG. 9 shows a flowchart of a method according to an embodiment of the present disclosure. The method shown in FIG. 9 may be used in an SN and comprises:

Step 901: transmitting, by a network node to a wireless communication node, a message in an initial access process or after the initial access process, to allow the wireless communication node to identify the network node according to the message.

In this embodiment, the network node is adopted to amplify signals between the wireless communication node and a user equipment.

In an embodiment, the network node is identified based on a Random Access Channel Occasion, RO, and a Physical Random Access Channel, PRACH, preamble.

In an embodiment, the network node is identified when the wireless communication node detects the PRACH preamble with a contention free PRACH preamble index corresponding to the network node during the RO.

In an embodiment, the network node is identified based on a contention-based Physical Random Access Channel, PRACH, preamble and a Random Access Radio Network Temporary Identifier, RA-RNTI.

In an embodiment, the network node is identified when the wireless communication node receives a reply for a Random Access Response, RAR, scrambled by a RA-RNTI corresponding to the network node.

In an embodiment, the network node is identified when the wireless communication node receives a reply for an RAR scrambled by the RA-RNTI with an offset corresponding to the network node.

In an embodiment, the network node is identified based on a content of a message of a scheduled transmission.

In an embodiment, the scheduled transmission is a scheduled transmission after a successful initial access process, or a data payload sent together with a preamble.

In an embodiment, the network node is identified when the wireless communication node receives an indication corresponding to the network node in a an identity field or in an establishment cause field in the content of the message.

In an embodiment, the network node is identified based on an indication corresponding to the network node in a higher layer message received from the network node.

In an embodiment, the higher layer message is a registration request, and a connection between the network node and the wireless communication node is released when the wireless communication node receives a registration rejection from a core network.

In an embodiment, the method further comprises: receiving, by the network node from the wireless communication node, an indication indicating that the network node is supported by the wireless communication node.

FIG. 10 shows a flowchart of a method according to an embodiment of the present disclosure. The method shown in FIG. 10 may be used in a BS and comprises:

Step 1001: receiving, by a wireless communication node (e.g. BS) from a network node, an identity report message (e.g. SN ID Report MAC CE) comprising an identity of the network node.

Step 1002: performing, by the wireless communication node, an authentication for the network node according to the identity of the network node.

In this embodiment, the network node is adopted to amplify signals between the wireless communication node and a user equipment.

In an embodiment, the method further comprises: transmitting, by the wireless communication node to the network node, a request (e.g. SN ID Report MAC CE) for the identity of the network node.

In an embodiment, the method further comprises: transmitting, by the wireless communication node to the network node, an access rejection (e.g. SN Access Reject MAC CE) in response to the authentication for the network node having failed.

In an embodiment, the identity report message is identified based on a Medium Access Control, MAC, subheader.

FIG. 11 shows a flowchart of a method according to an embodiment of the present disclosure. The method shown in FIG. 11 may be used in an SN and comprises:

Step 1101: transmitting, by a network node to a wireless communication node, an identity report message comprising an identity of the network node to allow the wireless communication node to perform an authentication for the network node according to the identity of the network node.

In this embodiment, the network node is adopted to amplify signals between the wireless communication node and a user equipment.

In an embodiment, the method further comprises: receiving, by the network node from the wireless communication node, a request for the identity of the network node.

In an embodiment, the method further comprises: receiving, by the network node from the wireless communication node, an access rejection in response to the authentication for the network node having failed.

In an embodiment, the identity report message is identified based on a Medium Access Control, MAC, subheader.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
performing, by a wireless communication node with a network node, an initial access process; and
identifying, by the wireless communication node, the network node according to a message from the network node in the initial access process or after the initial access process;
wherein the network node is adopted to amplify signals between the wireless communication node and a user equipment.

2. The wireless communication method of claim 1, wherein the network node is identified based on a Random Access Channel Occasion, RO, and a Physical Random Access Channel, PRACH, preamble.

3. The wireless communication method of claim 2, wherein the network node is identified when the wireless communication node detects the PRACH preamble with a contention free PRACH preamble index corresponding to the network node during the RO.

4. The wireless communication method of claim 1, wherein the network node is identified based on a contention-based Physical Random Access Channel, PRACH, preamble and a Random Access Radio Network Temporary Identifier, RA-RNTI.

5. The wireless communication method of claim 4, wherein the network node is identified when the wireless communication node receives a reply for a Random Access Response, RAR, scrambled by a RA-RNTI corresponding to the network node.

6. The wireless communication method of claim 4, wherein the network node is identified when the wireless communication node receives a reply for an RAR scrambled by the RA-RNTI with an offset corresponding to the network node.

7. The wireless communication method of claim 1, wherein the network node is identified based on a content of a message of a scheduled transmission.

8. The wireless communication method of claim 7, wherein the scheduled transmission is a scheduled transmission after a successful initial access process, or a data payload sent together with a preamble.

9. The wireless communication method of claim 7, wherein the network node is identified when the wireless communication node receives an indication corresponding to the network node in an identity field or in an establishment cause field in the content of the message.

10. The wireless communication method of claim 1, wherein the network node is identified based on an indication corresponding to the network node in a higher layer message received from the network node.

11. The wireless communication method of claim 10, wherein the higher layer message is a registration request, and a connection between the network node and the wireless communication node is released when the wireless communication node receives a registration rejection from a core network.

12. The wireless communication method of claim 1, further comprising:
transmitting, by the wireless communication node to the network node, an indication indicating that the network node is supported by the wireless communication node.

13. A wireless communication method comprising:
transmitting, by a network node to a wireless communication node, a message in an initial access process or after the initial access process, to allow the wireless communication node to identify the network node according to the message;
wherein the network node is adopted to amplify signals between the wireless communication node and a user equipment.

14. The wireless communication method of claim 13, wherein the network node is identified based on a Random Access Channel Occasion, RO, and a Physical Random Access Channel, PRACH, preamble.

15. The wireless communication method of claim 14, wherein the network node is identified when the wireless communication node detects the PRACH preamble with a contention free PRACH preamble index corresponding to the network node during the RO.

16. The wireless communication method of claim 13, wherein the network node is identified based on a contention-based Physical Random Access Channel, PRACH, preamble and a Random Access Radio Network Temporary Identifier, RA-RNTI.

17. The wireless communication method of claim 16, wherein the network node is identified when the wireless communication node receives a reply for a Random Access Response, RAR, scrambled by a RA-RNTI corresponding to the network node.

18. The wireless communication method of claim 16, wherein the network node is identified when the wireless communication node receives a reply for an RAR scrambled by the RA-RNTI with an offset corresponding to the network node.

19. The wireless communication method of claim 13, wherein the network node is identified based on a content of a message of a scheduled transmission.

20. A wireless communication method comprising:
receiving, by a wireless communication node from a network node, an identity report message comprising an identity of the network node; and
performing, by the wireless communication node, an authentication for the network node according to the identity of the network node;
wherein the network node is adopted to amplify signals between the wireless communication node and a user equipment.
